(19) United States
(12) Patent Application Publication
(10) Pub. No.: US 2025/0100852 A1
(43) Pub. Date: Mar. 27, 2025

(54) METHOD FOR MONITORING ELECTRICAL POWER CONSUMPTION OF A CRANE

(71) Applicant: MANITOWOC CRANE GROUP FRANCE, DARDILLY (FR)

(72) Inventors: Simon GRIMAUD, LYON (FR); Quentin BLASIAK, FLEURIEUX SUR L'ARBRESLE (FR)

(21) Appl. No.: 18/890,686

(22) Filed: Sep. 19, 2024

(30) Foreign Application Priority Data
Sep. 22, 2023 (FR) 2310071

(51) Int. Cl. B66C 13/48

(52) U.S. Cl. CPC B66C 13/48

(57) ABSTRACT

A monitoring method is designed, in a first step, to monitor and assess the electric power consumptions of the electrical equipment of a crane over a given time period. The electrical equipment includes actuation equipment contributing to at least one movement of the crane and accessory equipment not participating in a movement of the crane and responsible for power consumer functions. Once the time period is completed, the monitoring method is designed to determine whether, over the time period, the crane has, or has not, consumed too much power, this excessive consumption being deduced by comparing a supply power provided to the crane by at least one power supply source with the electric powers that the actuation equipment and the accessory equipment have consumed.

### FIELD

The present disclosure relates to a monitoring method intended for cranes.

More particularly, it relates to a monitoring method for controlling over a given time period the electric power consumptions of all of the electrical equipment of a crane in order to optimize use thereof and so that it consumes as less energy as possible.

The present disclosure finds a non-limiting application for all crane types, for example: tower cranes, jib cranes, lifting-boom cranes, telescopic-boom cranes, mobile cranes, port cranes.

### BACKGROUND

Nowadays, companies should positively comply with new regulations to make their ecological transition and put in practice behaviors for sustainable development, in order to bring in an overall and lasting solution to the major environmental concerns of this century, in particular in terms of energy consumption and pollutant emission reduction.

In a known manner, when it is used on a construction site, a crane is supplied with electric power by one or several power supply source(s) (for example: the electric power grid, a genset, a battery, etc.) in order to:
operate primarily electrical equipment included therein, so-called actuation equipment, in order to implement a movement of a movable element of the crane to displace it (that is to say, a translational movement) or for the displacement of a load (for example: a hoist, dispense, steer or lift movement),
heat or air-condition the operator cabin of the crane driver or the electrical cabinet,
etc.

Because of some practices and use habits, cranes generally consume much more electric power than needed for the tasks they are in charge of on the construction site, namely the load displacements. Indeed, electrical equipment of the crane may be powered during the completion of a task while these are not involved in the latter, whether directly or indirectly.

For illustration, if the power supply of the actuation equipment implementing a movement of a movable element of the crane is essential for said implementation, the power supply of the electrical equipment, so-called accessory equipment, used to heat the cabin of the crane driver is not necessary, in particular if the temperature inside the cabin is such that it already ensures comfort of the crane driver. Also, accessory equipment may be powered over long periods while this being useless. For example, in the case where the construction site is subjected to low outside temperatures, it is not necessarily useful, to ensure comfort in the cabin of the crane driver having to work in the morning, to power the accessory equipment in charge of heating the cabin overnight, but only a few hours before arrival of the crane driver.

Thus, part of the electric power provided to the crane is consumed uselessly and wasted, thereby significantly reducing the energy efficiency of the crane. Sometimes, the waster electric power may be equivalent to the useful electric power (i.e. an energy efficiency of the crane of 50%); the useful electric power corresponding to a total actuation power that results from the actuations of the different actuation equipment participating in the displacements.

This decrease in the energy efficiency becomes problematic when considering current ecological concerns, in particular with regards to global warming. This is why, in order to adopt an eco-friendly approach, crane manufacturers should propose solutions to improve the energy efficiency of their cranes.

Known solutions, like those of the documents CN216997307U and CN215208123U, aim to determine the energy efficiency of the crane but only in the context of execution of specific maneuvers (in this instance, for both documents, the maneuver of hoisting a load when the crane is active).

Thus, these solutions do not propose determining the electric power consumptions for all of the electrical equipment of the crane, and accurately determining its energy efficiency during deployment and use thereof on the construction site.

### SUMMARY

In order to address the problems set out before, the present disclosure proposes a monitoring method for monitoring over a time period an electric power consumption by electrical equipment of a crane, which crane being powered by a supply power provided by at least one power supply source, which electrical equipment comprising:
actuation equipment, wherein each of the actuation equipment comprises at least one motor controlled by a variable-speed drive and coupled to at least one movable element of the crane to actuate, in an active state, a displacement of said at least one movable element, otherwise, it is in an inactive state; and
accessory equipment which are not actuation equipment, in other words equipment that do not participate in the displacement of a movable element of the crane, and wherein each of the accessory equipment ensures a power consumer function specific thereto when it is in an active state, otherwise, it is in an inactive state;
said monitoring method being implemented by a control-command system connected to the variable-speed drive of the actuation equipment and connected to the accessory equipment to make them switch from the inactive state into the active state and vice versa;
said control-command system containing at least one memory and one processor defined by a cycle time, and
implementing, for each cycle time comprised within the time period, at least:
determining a state of each accessory equipment to determine whether it is in the active state or in the inactive state, and to deduce therefrom an accessory power consumed over the cycle time by said accessory equipment when it is in the active state, on the basis of an electric consumption model associated with said accessory equipment which is contained in the control-command system;
monitoring each actuation equipment comprising receiving, from the corresponding variable-speed drive, an actuation power consumed over the cycle time by said actuation equipment when it is in the active state.

Advantageously, the monitoring method of the present disclosure positively addresses the problem of knowing the powers consumed by all of the equipment of the crane by allowing, over a time period (which could correspond for example to one day, one week, one month, or one year): monitoring the electric power consumption of a crane, more specifically of its electrical equipment, in comparison with the supply power provided by the at least one power supply source (for example: the electric power grid, a genset, a rechargeable power supply source like a battery).

The powers consumed by the electrical equipment are determined by the control-command system of the crane.

Among the electrical equipment, one could distinguish between:
so-called actuation equipment contributing to the displacement of movable elements of the crane for mounting thereof, displacement thereof, or to enable the crane to displace a load (the crane being so-called on-service, working); and
so-called accessory which do not contribute to the displacement of movable elements of the crane, but still fill a power consumer function, for example to heat or air-condition the operator cabin of the crane driver.

A non-exhaustive list of actuation equipment and of accessory equipment is provided hereinbelow.

An actuation equipment (respectively an accessory equipment) is so-called active when it contributes to the movement of the at least one movable element with which it is associated (respectively when it implements the power consumer function assigned thereto); the actuation equipment (respectively the accessory equipment) being so-called inactive otherwise.

The control-command system comprises at least one memory and a processor defined by a cycle time; this cycle time being a piece of data intrinsic to the processor of the control-command system, which reflects the time necessary for the repetition of a given operation and which is related to the computing speed of the processor. More specifically, it is this processor which implements the monitoring method, by executing a program containing a list of instructions relating to the latter.

In the context of the implementation of the monitoring method, the time period is considered being segmented according to the cycle time of the processor. In other words, the time period is constituted by a plurality of time intervals that are equal to the cycle time. Next, it is said that the time period is composed of a plurality of cycle times.

Over the cycle times segmenting the time period, the control-command system knows the state of the electrical equipment, that is to say whether they are active or inactive.

In the case of active actuation equipment, the control-command system knows the power that said actuation equipment consumes over the cycle time following the reception of a measurement of said power, which is measured by a variable-speed drive included in the actuation equipment and to which the control-command system is connected. Indeed, the variable-speed drives comprises energy consumption meters. The power that the actuation equipment consumes is so-called actuation power.

In the case of an active accessory equipment, the control-command system knows the power that said accessory equipment consumes over the cycle time by calculating it from a mathematical model corresponding to an electric consumption model of the accessory equipment, which is contained in the control-command system. The power that the accessory equipment consumes is so-called accessory power.

Advantageously, the use of electric consumption models allows not installing on the crane measurement devices intended to measure the accessory powers, which devices would need to be supplied with power to proceed with the measurements. Consequently, the use of electric consumption models allows reducing the energy consumption of the crane. The electric consumption models also allow reducing costs in terms of measurement device purchase.

According to a feature of the present disclosure, the control-command system implements, subsequently to the time period, at least:
calculating, for each of the accessory equipment, a cumulated accessory power consumed over the time period by said accessory equipment, by summing up the accessory powers consumed over the cycle times where it has been in the active state;
calculating, for each of the actuation equipment, a cumulated actuation power consumed over the time period by said actuation equipment, by summing up the actuation powers consumed over the cycle times where it has been in the active state;
deducing a total accessory power corresponding to the sum of the cumulated accessory powers consumed over the time period by all of the accessory equipment;
deducing a total actuation power corresponding to the sum of the cumulated actuation powers consumed over the time period by all of the actuation equipment;
comparing the supply power, the total accessory power and the total actuation power.

Advantageously, the monitoring method enables an operator to know the total power that each electrical equipment had consumed over the elapsed time period. This total power is so-called cumulated actuation power when the electrical equipment is an actuation equipment, and cumulated accessory power when the electrical equipment is an accessory equipment.

Also, the monitoring method enables an operator to know which are the parts of the total actuation power (that is to say the useful power) and of the total accessory power in the electrical energy consumption of the crane (in other words, the supply power).

Thus, the operator is capable of concluding whether, over the time period, the crane has consumed too much power (that is to say when the total accessory power is higher than the useful power in the electrical energy consumption of the crane), and of determining the origins of this excess (that is to say identifying the electrical equipment having consumed too much power).

Herein again, the present disclosure addresses the problems set out before by enabling the operator to accurately determine the energy efficiency over a time period during which said crane could be deployed and/or used on a construction site, which energy efficiency is equal, as specified again hereinbelow, to the total actuation power divided by the supply power.

According to a feature of the present disclosure, subsequently to the time period, the control-command system constitutes a set of power data comprising at least:
the cumulated accessory powers of all of the accessory equipment over the time period,
the cumulated actuation powers of all of the actuation equipment over the time period,
the total accessory power,
the total actuation power, and
the supply power;
which set of power data is time-stamped over the time period and then recorded in the memory of the control-command system.

In other words, the powers calculated by the control-command system and listed hereinbefore are grouped by the latter into a set of power data time-stamped thereby and stored in its memory.

Advantageously, the sets of power data are therefore temporally classified according to the time period (day, week, month, or year) during which they have been calculated. Hence, the calculated powers are not lost once the monitoring process is completed, and an operator can consult them later on to analyze the energy behavior of the crane.

Also, it is provided for the memory of the control-command system being able to store the sets of power data of several time periods, thereby enabling the operator to observe/analyze an evolution of the energy behavior of the crane over a long time period, which could for example correspond to several successive time periods, and possibly identify energy consumption anomalies (the crane having been able to consume more power over a given time period in comparison with the others).

According to a feature of the present disclosure, the set of power data can be exported from the control-command system towards a digital twin of the crane modeled in a remote computer infrastructure, the set of power data being set in a data format compatible with the digital twin in order to be exploited by the latter.

Advantageously, the use of a digital twin for which at least one set of power data is exploited enables an operator to reproduce the context of deployment and/or use of the crane over at least one time period. Thus, in the case where an excessive power consumption would have been observed over the at least one time period describing a given application context on a construction site, the operator can use the digital twin to reach scenarios for which the electric consumption of the crane is optimized for said at least one time period. Next, these scenarios could then be used/exploited by being concretely reproduced on the construction site should said application context be encountered again, that being so in order to best manage the energy consumption of the crane. For example, the optimization of the power consumption may result from less activity of the accessory equipment, from a better use of the crane when it is on-service or working (optimization of the movements of the crane), etc.

According to an embodiment of the present disclosure, the control-command system calculates, subsequently to the time period, an energy efficiency which is equal to the total actuation power divided by the supply power.

According to an embodiment of the present disclosure the set of power data also comprises the energy efficiency.

According to a feature of the present disclosure, the control-command system determines, at each cycle time comprised within the time period, and according to a least one electrical equipment amongst the actuation equipment and the accessory equipment in the active state, at least one state of the crane amongst at least one off-service state in which all of the actuation elements are in the inactive state, and at least one on-service state in which at least one of the actuation elements is in the active state.

In other words, over each cycle time, the control-command system is capable of determining whether the crane is in an off-service state or in an on-service state.

As indicated before, the crane is considered as being in an off-service state when no actuation element is in the active state. However, in the off-service state, the accessory equipment may be on service or not. The off-service state may correspond to a time during which the crane is inactive, for example: when it is in deep sleep mode; when no actuation equipment is active and the operator cabin is preheated or air-conditioned; etc.

The crane is considered as being in an on-service state when at least one actuation element is in the active state to contribute to a movement of the movable element. In other words, in the on-service state, the crane may be: ongoing deployment on a construction site; or piloted by a crane driver in order to be displaced or displace a load.

According to an embodiment of the present disclosure, when the at least one state of the crane corresponds to the on-service state for a given cycle time, the control-command system associates for each of the actuation equipment a movement selected at least amongst:
a dispense movement associated with a dispensing equipment amongst the actuation equipment during which a maneuver of dispensing a load along a jib of the crane is performed,
a hoist movement associated with a hoisting equipment amongst the actuation equipment during which a maneuver of hoisting a load is performed,
a steer movement associated with a steering equipment amongst the actuation equipment during which a maneuver of steering a jib is performed,
a translational movement associated with a translation equipment amongst the actuation equipment during which a maneuver of translating the crane is performed,
a lift movement associated with a lifting equipment amongst the actuation equipment during which a maneuver of lifting a lifting jib is performed, or
a mount movement during which mounting of the crane is performed, which mount movement is associated with a mounting equipment amongst the actuation equipment and selected at least amongst: a folding/unfolding equipment for folding/unfolding a mast and a jib, an anchoring equipment for anchoring the crane to the ground, a steering equipment for steering a base of the crane, a post equipment for actuating a mounting post.

According to an embodiment of the present disclosure, when the at least one state of the crane corresponds to the off-service state for a given cycle time, the control-command system associates for each of the accessory equipment the consumer function selected at least from amongst:
a heating function associated with a heating equipment amongst the accessory equipment for heating an operator cabin of the crane, and
an air-conditioning function associated with an air-conditioning equipment amongst the accessory equipment for conditioning an operator cabin of the crane.

In other words, depending on the actuation equipment and/or accessory equipment in the active state over a cycle time, the control-command system is capable of determining which movement the crane is implementing and/or which power consumer function is currently active.

Advantageously, over a cycle time, the control-command system is capable of associating a consumed power (an actuation power or an accessory power) to: a state of the crane (on-service or off-service); as well as a movement of the crane or an energy consumer function. Thus, subsequently, during the analysis of the set of power data, the operator is capable of deducing for the time period the power consumed to implement a given movement or energy consumer function.

Also, if several pieces of actuation equipment (respectively several accessory equipment) contribute, over a time period, to a movement of a movable element (respectively to an energy consumer function), the operator could know, at the end of the time period, the power consumed by each of these to implement said movement (respectively said energy consumer function).

Advantageously, the monitoring method therefore allows processing and classifying the cumulated powers consumed by the electrical equipment of a crane over time (that is to say according to the time period), according to the state of the crane, and the implemented movement or energy consumer function; that being impossible to do with a measurement system external to the crane without integrating some intelligence thereto.

According to an embodiment of the present disclosure, the electric consumption model of each of the accessory equipment contains, in order to calculate the accessory power, at least:
the cycle time,
a power supply voltage for powering said accessory equipment when in the active state,
a consumption current of the accessory equipment.

In other words, the accessory power of an accessory equipment over a cycle time is calculated from: the cycle time; the power supply voltage necessary to power the accessory equipment; and the current consumed by the accessory equipment over the cycle time, which is considered to be uniform.

According to an embodiment of the present disclosure, the cycle time is equal to 50 milliseconds, within a 20% margin.

According to an embodiment of the present disclosure, the control-command system generates, subsequently to the time period, an analysis report containing at least the set of power data of the time period.

Advantageously, the analysis report comprises all of the powers calculated over the time period (cumulated accessory powers of all of the accessory equipment, cumulated actuation powers of all of the actuation equipment, total accessory power, total actuation power, supply power) to enable the user to analyze the energy behavior of the crane over the time period.

It may be considered that the analysis report contains the energy efficiency calculated by the control-command system for the time period.

It may also be considered that the analysis report contains the sets of power data of several time periods.

Also, it may be considered that the analysis report contains a classification of the cumulated powers of the electrical equipment of the crane according to: the time periods; the state of the crane; and the implemented movement or energy consumer function.

Finally, in connection with the previous point, it may be considered that the analysis report contains one or several graphical representation(s) showing a distribution of the supply power according to:
the state of the crane,
the implemented movement or energy consumer function,
the actuation equipment and accessory equipment (that is to say according to the actuation powers, the cumulated actuation powers, the accessory powers, the cumulated accessory powers), and
the total actuation power and the total accessory power.

According to one possibility, the supply power is measured by a general electrical meter connected to the control-command system.

In other words, it is provided to measure the supply power, by means of the general electrical meter (such as a meter provided by the utility company), which could be positioned upstream of the at least one power supply source or at the entrance of the crane, and the control-command system recovers this measurement of the supply power.

### BRIEF DESCRIPTION OF THE DRAWINGS

Other features and advantages of the present disclosure will appear upon reading the detailed description hereinafter, of a non-limiting example of implementation, made with reference to the appended figures, wherein:

FIG. 1 is an illustration of an application context in which the method of the present disclosure is implemented, which shows in particular a crane deployed on a construction site, a power supply source providing the crane for powering thereof with a supply power, and a general electrical meter measuring said supply power;

FIG. 2 is a schematic illustration of a crane comprising at least one control-command system installed in an operator cabin, electrical equipment including actuation equipment contributing to the implementation of movements of the crane, and accessory equipment not participating in a movement of the crane but ensuring a power consumer function like heating or air-conditioning of the operator cabin of the crane;

FIG. 3 is a flowchart of the monitoring method of the present disclosure, which assesses over a given time period the powers consumed by the different electrical equipment of the crane, that being so in order to determine whether the crane has consumed too much power with regards to the supply power that is provided thereto; and

FIG. 4 shows examples, in the context of an embodiment of the present disclosure, of graphical representation showing a distribution, for a given time period, of the supply power: (a) according to the power consumed by all of the actuation equipment and the power consumed by all of the accessory equipment, respectively so-called total actuation power and total accessory power, or (b) according to the actuation equipment and accessory equipment, or (c) according to the implemented movements and power consumer functions.

### DESCRIPTION

The present disclosure relates to a monitoring method 100 allowing assessing, over a given time period T (for example, one day, one week, one month, etc.), the powers consumed by all of the equipment of a crane 1 deployed and being implemented in a construction site; that being so for these power consumptions to be analyzed later on in order to determine whether the crane 1 has, or not, consumed too much power according to use thereof over the time period T and, if so, reach solutions allowing optimizing its power consumption during future uses thereof.

The monitoring method could be applied to all crane 1 types: tower cranes, jib cranes, lifting-boom cranes, telescopic-boom cranes, mobile cranes, port cranes.

In the following description, it is considered that the crane 1 is a lifting-boom crane.

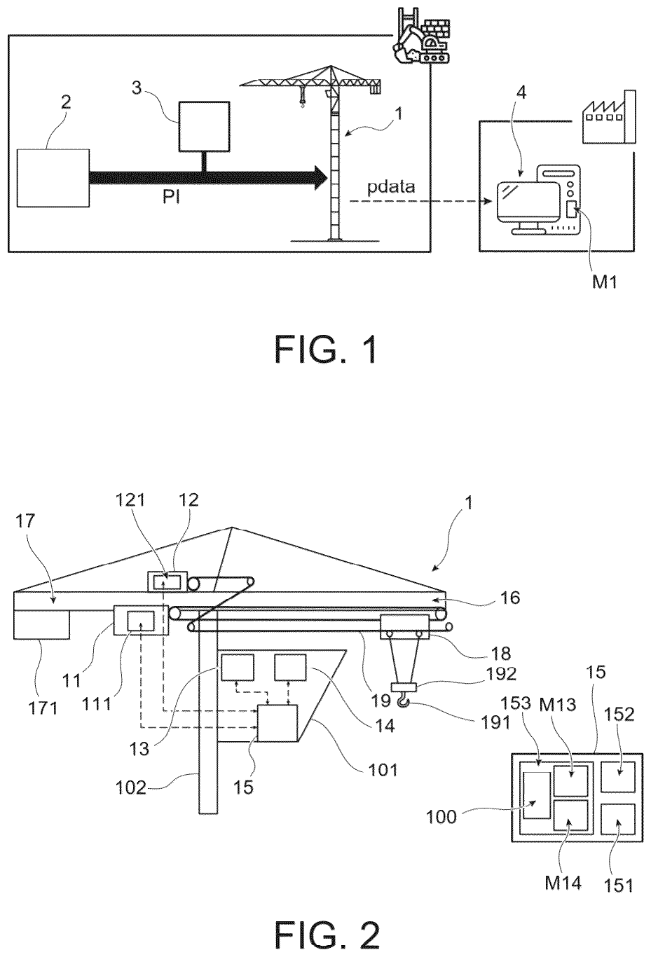

Referring to FIGS. 1 and 2, the crane 1 comprises at least one mast 102 and a rotating assembly rotating about a steering axis extending vertically, and formed by a jib 16 and a counter-jib 17, substantially aligned, and possibly a tower peak (or apex) with tie-rods. A counterweight 171 is carried by the counter-jib 17 to counterbalance the weight of a load that is lifted and/displaced by the crane 1.

The load is attached by means of a hoisted hook 191 located at the end of a reeve-block 192, which is displaced vertically in the direction of the jib 16 or lowered depending on winding or unwinding of a hoist rope 19.

The hoist rope 19 hangs to a dispenser carriage 18 movable in translation on a rolling track provided along the jib 16.

The crane 1 also comprises an operator cabin 101 in which the crane driver is seated and in which a control-command system 15 is located from which the crane driver maneuvers the crane 1.

The control-command system 15 comprises at least one memory 152, a processor 151 defined by a cycle time tc, and a program 153 containing a list of instructions for starting and executing the monitoring method 100.

By definition, a crane also comprises a plurality of electrical equipment 11, 12, 13, 14 which comprise, without limitation: a hoist winch 12; a dispense winch 11; a heating equipment 13 and an air-conditioning equipment 14 both installed in the cabin 101. These four pieces of electrical equipment 11, 12, 13, 14 are considered later on to explain the operation principle of the monitoring method 100. As it has just been indicated, these form only part of the electrical equipment that the crane 1 could comprise in practice.

The implementation of the monitoring method 100 is based in part on a classification of the electrical equipment 11, 12, 13, 14 according to their role/attribution. Thus, one could distinguish the electrical equipment so-called actuation equipment 12, 13 from those so-called pieces of accessory equipment 13, 14.

The actuation equipment 11, 12 are electrical equipment that comprise at least one motor controlled by a variable-speed drive 111, 121, and coupled at least to a movable element 18, 19 of the crane to implement, when they are in an active state A11, A12, a displacement of said at least one movable element 18, 19 at the origin of a movement Mvt11, Mvt12. The variable-speed drives 111, 121 controlling the motors of the actuation equipment 11, 12 are connected to the control-command system 15.

Referring to FIG. 2, as actuation equipment, the crane 1 comprises:
a dispensing equipment 11, that is to say the dispense winch, which is coupled at least to a movable element 18, that is to say the dispenser carriage 18, to implement a dispense movement Mvt11 during which the dispenser carriage is movable in translation from the front to the rear of the jib 16, and vice versa;
a hoisting equipment 12, that is to say the hoist winch, which is coupled at least to a movable element 19, that is to say the hoist rope, to implement a hoist movement Mvt12 during which the hoist winch winds or unwinds the hoist rope 19, in order to vertically displace the reeve-block 192 in the direction of the jib 16 or of the ground to raise or lower a load.

Not illustrated in FIG. 2 and not considered in the following description, as actuation equipment, mention may also be made of:
a steering equipment, for example a steering electric motor, associated with a steering crown to implement a steer movement during which the jib 16, or more generally the rotating assembly of the crane 1, sweeps a circular area around the steering axis, which circular are corresponds to the work area of the crane;
a translation equipment designed so as to implement a translation maneuver of the crane 1, which could, for example, be mounted on rails if it is intended to be displaced in construction site;
the mounting equipment designed so as to implement a mount movement of the crane, for example, yet without limitation: a folding/unfolding equipment for folding/unfolding the mast 102 and a jib 16, an anchoring equipment for anchoring the crane 1 to the ground, a steering equipment for steering a base of the crane 1, a post equipment for actuating a mounting post, etc. These pieces of mounting equipment may be selected, for example yet without limitation, among electric motor or hydraulic units.

In the case of lifting-boom cranes, the actuation equipment, among those mentioned before, do not comprise any dispensing equipment since these cranes do not comprise a dispenser carriage. Indeed, for this crane type, the jib is angularly lowered and raised by means of at least one lifting rope. Thus, the load is raised according to the inclination of the jib and therefore according to winding or unwinding of the hoist rope. Therefore, the pieces of actuation equipment of a lifting-boom crane comprise, on the contrary, a lifting equipment (such as a lifting winch) designed so as to implement a lift movement of the lifting jib by winding and unwinding the lifting rope for this purpose.

The accessory equipment 13, 14 are electrical equipment that do not participate in the displacement of a movable element 18, 19 of the crane 1, but which ensure a power consumer function F13, F14 specific thereto when they are in an active state A13, A14. Referring to FIG. 2, the illustrated accessory equipment corresponds to the heating equipment 13, which ensures a heating function F13 for heating the cabin 101, and to the air-conditioning equipment 14, which ensures an air-conditioning function F14 for air-conditioning the cabin 101.

When they do not respectively implement a movement Mvt11, Mvt12 and a consumer function F13, F14, the actuation 11, 12 and accessory 13, 14 equipment are so-called in the inactive state NA11, NA12, NA13, NA14.

The switches of electrical equipment 11, 12, 13, 14 from the active state A11, A12, A13, A14 into the inactive state NA11, NA12, NA13, NA14, and vice versa, are managed from and by the control-command system 15.

The crane 1 is so-called in an on-service state OP1 when at least one actuation equipment 11, 12 is in the active state A11, A12; that being so independently of the state of the accessory equipment 13, 14. In other words, in the on-service state OP1, the crane 1 may be: ongoing deployment on a construction site; or piloted by a crane driver in order to be displaced or displace a load.

In other words, the crane is so-called in an off-service state NOP1 when all of the actuation equipment 12, 13 are in the inactive state NA11, NA12, whether the accessory equipment 13, 14 are in the active A13, A14 or inactive NA13, NA14 state. Thus, the off-service state NOP1 may correspond to a time during which the crane 1 is inactive, for example: when it is in deep sleep mode (all of the electrical equipment 11, 12, 13, 14 are in the inactive state NA11, NA12, NA13, NA14); when the actuation equipment 11, 12 are inactive but the operator cabin 101 is preheated or air-conditioned (meaning that the heating equipment 13 or the air-conditioning equipment 14 ensures its consumer function F13, F14); etc.

Over the time period T, in order to power its electrical equipment 11, 12, 13, 14 in the active state A11, A12, A13, A14, receives a supply power PI originating from at least one power supply source 2, the at least one power supply source 2 could, without limitation, correspond: to the electric power grid, to a genset, to a rechargeable power supply source like a battery.

The supply power PI is measured by a general electrical meter 3 at least in communication (via a wired or wireless link) with the control-command system 15. According to different embodiments of the present disclosure, the general electrical meter 3 may be positioned upstream of the at least one power supply source 2, or at the entrance of the crane 1. Thus, the control-command system 15 recovers the measurement of the supply power PI originating from the general electrical meter 3.

Besides the classification of the electrical equipment 11, 12, 13, 14, the monitoring method 100 is based on a segmentation of the time period T according to the duration of the cycle time tc of the processor 151. In an embodiment of the present disclosure, the duration of the cycle time tc is equal to 50 milliseconds, within a 20% margin. Thus, the duration of the time period T is equal to a plurality of cycle times tc1, tcn following one another, the plurality of cycle times comprising at least one first cycle time tc1 and one last cycle time tcn.

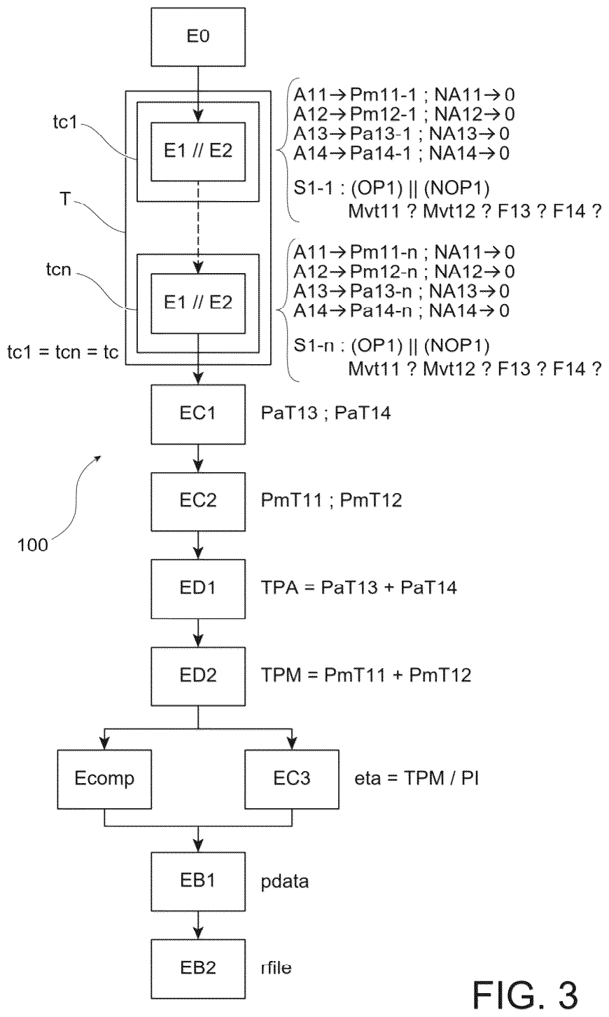

A flowchart of the monitoring method 100 is shown in FIG. 3, which starts being executed following a start E0. The time period T is considered as beginning in time following the implementation of the start E0.

For each of the cycle times tc1, tcn constituting the time period T, the monitoring method 100 will implement, for example in parallel as illustrated in FIG. 3:
determining E1 the state A13, NA13, A14, NA14 of each of the accessory equipment 13, 14. In the case where the accessory equipment 13, 14 is in the active state A13, A14, the monitoring method 100 (more specifically, the control-command system 15) will calculate an accessory power Pa13-1, Pa13-n, Pa14-1, Pa14-n consumed by the accessory equipment 13, 14 over the cycle time tc1, tcn. This calculation is specified hereinbelow in the text. In the case where the accessory equipment 13, 14 is in the active state NA13, NA14 over the cycle time tc1, tcn, the monitoring method 100 concludes that the accessory equipment 13, 14 consumes no accessory power Pa13-1, Pa13-n, Pa14-1, Pa14-n (in other words, the power consumption is zero);
monitoring E2 each actuation 11, 12 during which, when the actuation equipment 11, 12 is in the active state A11, A12 over the cycle time tc1, tcn, the control-command system 15 receives, from the variable-speed drive 111, 121 associated with the actuation equipment 11, 12, a measurement corresponding to the actuation power Pm11-1, Pm11-n, Pm12-1, Pm12-n consumed by the actuation equipment 11, 12 over the cycle time tc1, tcn. The variable-speed drives 111, 121 are capable of transmitting the actuation power Pm11-1, Pm11-n, Pm12-1, Pm12-n to the control-command system 15 as they comprise energy consumption meters. When the actuation equipment 11, 12 is in the inactive state NA11, NA12 over the cycle time tc1, tcn, its power consumption is zero.

The accessory powers Pa13-1, Pa13-n, Pa14-1, Pa14-n consumed by the accessory equipment 13, 14 are calculated from mathematical models so-called electric consumption models M13, M14 contained in the control-command system 15, more specifically in the program 153. Each of the electric consumption models M13, M14 contains at least:
the value of the cycle time tc (for example, as indicated hereinabove, equal to 50 ms), which also corresponds to the values of all of the cycle times tc1, tcn of the time period);
a power supply voltage U13, U14 necessary to power the accessory equipment 13, 14 when it is in the active state A13, A14;
a consumption current 113, 114 of the accessory equipment 13, 14.

The accessory powers Pa13-1, Pa13-n, Pa14-1, Pa14-n of the accessory equipment 13, 14 over a cycle time tc1, tcn are then calculated according to the following equations:

$$( PA 13 - 1 , Pa 13 - n ) = tc * U 13 * I 13 \qquad Eq . 1$$

$$( PA 14 - 1 , Pa 14 - n ) = tc * U 14 * I 14 \qquad Eq . 2$$

The use of electric consumption models M13, M14 for the determination of the accessory powers Pa13-1, Pa13-n, Pa14-1, Pa14-n of the accessory equipment 13, 14 allows not installing on the crane 1 measurement devices intended to measure said powers and which would, in turn, need to be supplied with power to proceed with the measurements. Consequently, the use of electric consumption models M13, M14 allows reducing the energy consumption of the crane 1. The electric consumption models also allow reducing costs in terms of measurement device purchase.

Referring to FIG. 3, the monitoring method 100 comprises at least one set of steps EC1, EC2, ED1, ED2, Ecomp taking place subsequently to the time period T (for example, immediately after completion thereof) and implemented by the control-command system 15. This set of steps EC1, EC2, ED1, ED2, Ecomp comprises:
calculating EC1, for each of the accessory equipment 13, 14 a cumulated accessory power PaT13, PaT14 that it has consumed over the time period T, which is equal to the sum of the accessory powers Pa13-1, Pa14-1, Pa13-n, Pa14-n consumed over the cycle times tc1, tcn where it has been in the active state A13, A14. Possibly, this cumulated accessory power PaT13, PaT14 may be equal to zero if, throughout the time period T, the accessory equipment 13, 14 has been in the inactive state NA13, NA14;
calculating EC2, for each of the actuation equipment 11, 12, a cumulated actuation power PmT11, PmT12 that it has consumed over the time period T, which is equal to a sum of the actuation powers Pm11-1, Pm11-1, Pm12-n, Pm12-n consumed over the cycle time tc1, tcn where it has been in the active state A11, A12. Possibly, this cumulated actuation power PmT11, PmT12 may be equal to zero if, throughout the time period T, the actuation equipment 11, 12 has been in the inactive state NA11, NA12;
deducing ED1 a total accessory power TPA corresponding to the sum of the cumulated accessory powers PaT13, PaT14 consumed over the time period T by all of the accessory equipment 13, 14;
deducing ED2 a total actuation power TPM corresponding to the sum of the cumulated actuation powers PmT11, PmT12 consumed over the time period T by all of the actuation equipment 11, 12;
comparing Ecomp the supply power PI measured by the general electrical meter 3, the total accessory power TPA and the total actuation power TPM.

In another embodiment of the present disclosure, it may be considered that the calculations EC1, EC2 are carried out in parallel rather than successively, the same applying for the deductions ED1, ED2.

In an embodiment of the present disclosure, it may be considered that, before the start E0 intended to start the monitoring method 100 from the dedicated program 153 contained in the control-command system 15, an operator (for example the crane driver) enters in said program 153 the duration of the time period T. Thus, steps EC1, EC2, ED1, ED2 of the monitoring method 100 carried out subsequently to the time period T are implemented automatically by the control-command system 15 once the latter is completed.

In another embodiment of the present disclosure, it may be considered that the time period finishes following a manual interaction of the operator with a menu/an option proposed by the program 153, this interaction putting an end by the monitoring 100 program 153 to the implementation of the determination E1 of the accessory powers Pa13-1, Pa13-n, Pa14-1, Pa14-n and of the actuation powers Pm11-1, Pm11-n, Pm12-1, Pm12-n over several successive cycle times tc1, tcn. Following this manual stoppage, the steps EC1, EC2, ED1, ED2, Ecomp of the monitoring method are implemented by the control-command system 15.

By definition, the supply power PI is equal to the sum of the total accessory power TPA with the total actuation power TPM.

Thanks to the comparison Ecomp, an operator could conclude whether, over the time period T, the crane 1 has consumed too much power, that could be reflected in a given context by a total accessory power TPA higher than the total actuation power TPM. Also, the knowledge of the cumulated accessory powers PaT13, PaT14 and of the cumulated actuation powers PmT11, PmT12 enables the operator to identify the electrical equipment 11, 12, 13, 14 at the origin of this excessive power consumption.

The knowledge of the cumulated accessory powers PaT13, PaT14 and of the cumulated actuation powers PmT11, PmT12 also enables the operator to determine whether, in a given application context, an electrical equipment 11, 12, 13, 14 has not uselessly consumed power even though the total accessory power TPA is lower than the total actuation power TPM. For example: the operation of the heating equipment 13 while, without heating, the temperature inside the operator cabin 101 is such that it already ensures comfort of the crane driver.

For the operator to be able to draw conclusions on the operation of the electrical equipment 11, 12, 13, 14 during the time period T, the monitoring method 100 comprises the constitution EB1 of a set of power data pdata comprising at least:
the cumulated accessory powers PaT13, PaT14 of all of the accessory equipment 13, 14 over the time period T,
the cumulated actuation powers PmT11, PmT12 of all of the actuation equipment 11, 12 over the time period T,
the total accessory power TPA,
the total actuation power TPM, and
the supply power PI.

The set of power data pdata is time-stamped over the time period T (which may correspond to one day, one week, one month, one year, etc.) and then recorded in the memory 152 of the control-command system 15. Thus, an operator could use the control-command system to subsequently consult the set of power data pdata and thus analyze the energy behavior of the crane 1 over the time period T.

It may be considered that the memory 152 of the control-command system 15 is designed so as to store several sets of power data pdata each corresponding to a distinct time period T. Thus, the operator could observe/analyze an evolution of the energy behavior of the crane 1 over a long time period, which could for example correspond to several successive time periods T, and potentially identify energy consumption anomalies over this long time period; the crane having been able to consume more power over a given time period T in comparison with the others.

In one embodiment, the analysis of the set of power data pdata is also possible from a remote computer infrastructure 4 which could be located on the construction site or, as illustrated in FIG. 1, be located on another geographic site. It may be considered, in one embodiment of the present disclosure, that the control-command system 15 could communicate with the remote computer infrastructure 4 to send the set of power data pdata thereto. In another embodiment, an operator could use a storage means, for example a USB flashdisk (USB, standing for Universal Serial Bus), to recover from the control-command system 15 the set of power data pdata and, subsequently, transfer it into the remote computer infrastructure 4.

In an embodiment of the present disclosure, it is also provided for the remote computer infrastructure 4 containing a digital twin M1 of the crane 1 allowing simulating and reproducing application contexts of cranes maneuvering in construction sites. The interest of such a digital twin M1 is to be able to reproduce the energy behavior of the crane 1 over a time period T for which an excessive power consumption would have been observed. To this end, in this embodiment, the set of power data pdata is intended to be in a format compatible with the digital twin M1. By using the digital twin M1 and the set of power data pdata, an operator could simulate, for the application context of the particular site associated with this time period T, several power consumption scenarios until reaching optimum scenarios for which the electric consumptions of the electrical equipment 11, 12, 13, 14 of the crane 1 are optimized. Consequently, if this particular application context should happen again on the construction site, the optimum scenarios would then allow for a better energy management of the electric power consumption of the crane 1. For example, the optimization of the power consumption of the crane 1 may result from less activity of the accessory equipment 13, 14, from a better use of the crane 1 when it is in service or working (optimization of the movements Mvt11, Mvt12), etc.

In an embodiment of the present disclosure, as illustrated in FIG. 3, it may be considered that the monitoring method 100 comprises, in parallel with the comparison Ecomp, an optional calculation EC3 of an energy efficiency eta of the crane 1, this energy efficiency eta being equal to the total actuation power TPM divided by the supply power PI. This energy efficiency eta may possible be part of the power data contained in the set of power data pdata.

In an embodiment of the present disclosure, during each of the cycle times tc1, tcn of the time period T, the monitoring method 100 is capable of determining a state S1-1, S1-n of the crane amongst the on-service state OP1 and the off-service state NOP1; this depends on the actuation equipment 11, 12 and the accessory equipment 13, 14 are in the active state A11, A12, A13, A14 or in the inactive state NA11, NA12, NA13, NA14. The states A11, A12, A13, A14, NA11, NA12, NA13, NA14 of the electrical equipment 11, 12, 13, 14 also enable the monitoring method 100 to determine which are the movements Mvt11, Mvt12 and/or the consumer functions F13, F14 implemented during the cycle times tc1, tcn.

Thus, subsequently, during the analysis of the set of power data pdata, the operator is capable of deducing, for the time period T, the consumed power to implement a given movement Mvt11, Mvt12 or consumer function F13, F14.

Also, if several actuation equipment 11, 12 (respectively several accessory equipment 13, 14) contribute, over a time period T to a movement Mvt11, Mvt12 of a movable element 18, 19 (respectively to a consumer function F13, F14), the operator can know, upon completion of the time period T, the power consumed by each of them to implement said movement Mvt11, Mvt12 (respectively said power consumer function F13, F14).

Advantageously, the monitoring method 100 allows processing and classifying the cumulated powers PmT11, PmT12, PaT13, PaT14 consumed by the electrical equipment 11, 12, 13, 14 of the crane 1 over the time period T according to: the state OP1, NOP1 of the crane 1, and the implemented movement Mvt11, Mvt12 or power consumer function F13, F14; that being impossible to do with a measurement system external to the crane without integrating some intelligence thereto.

In an embodiment of the present disclosure, in order to facilitate for the operator the analysis of the power consumptions of the electrical equipment 11, 12, 13, 14 over the elapsed time period T, the monitoring method 100 may comprise, subsequently to the time period T, in parallel with the constitution EB1 of the set of power data pdata or following the latter, a generation EB2 of an analysis report rfile containing at least the set of power data pdata of the time period T, which is contained in and consultable from the control-command system 15.

In a variant of the present disclosure, the analysis report can be transferred towards one or several remote computer infrastructure(s) 4.

The generation EB2 of the analysis report rfile being optional, it may be considered that the latter is for example associated with an option proposed by the program 153 to the operator. It may also be considered that the program 153 also proposes generating an analysis report rfile containing the set of power data pdata of the last elapsed time period T, but also the sets of power data pdata relating to prior time periods T.

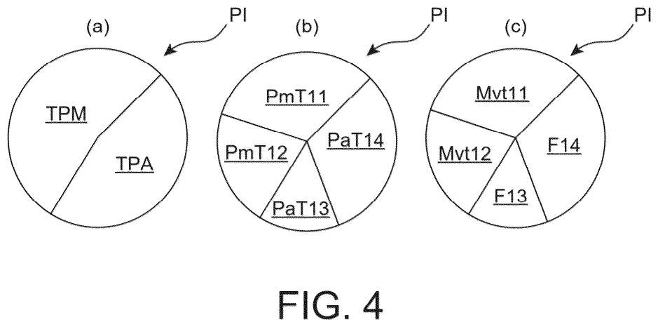

In an embodiment of the present disclosure, the analysis report rfile may contain a classification of the cumulated powers PmT11, PmT12, PaT13, PaT14 of the electrical equipment 11, 12, 13, 14 according to: the time periods T; the state OP1, NOP1 of the crane 1; and the implemented movements Mvt11, Mvt12 or power consumer functions F13, F14. Referring to FIG. 4, it may also be considered that the analysis report rfile contains for the time period T one or several graphical representation(s) showing a distribution of the supply power PI, for example, yet without limitation, according to:
the state OP1, NOP1 of the crane 1;
the total actuation power TPM and the total accessory power TPA (FIG. 4-a);
the actuation equipment 11, 12 and the accessory equipment 13, 14, that is to say according to the cumulated actuation powers PmT11, PmT12 and the cumulated accessory powers PaT13, PaT14 (FIG. 4-b);
the implemented movements Mvt11, Mvt12 and/or power consumer functions F13, F14 (FIG. 4-c).

1-12. (canceled)

13. A monitoring method for monitoring over a time period an electric power consumption by electrical equipment of a crane, the crane being powered by a supply power provided by at least one power supply source, the electrical equipment comprising:
actuation equipment, wherein each of the actuation equipment comprises at least one motor controlled by a variable-speed drive and coupled to at least one movable element of the crane to actuate, in an active state, a displacement of said at least one movable element, otherwise, it is in an inactive state; and
accessory equipment which are not actuation equipment, and wherein each of the accessory equipment ensures a power consumer function specific thereto when it is in an active state, otherwise, it is in an inactive state;
said monitoring method being implemented by a control-command system connected to the variable-speed drive of the actuation equipment and connected to the accessory equipment to make them switch from the inactive state into the active state and vice versa;
said control-command system containing at least one memory and one processor defined by a cycle time, and the monitoring method including:
implementing, for each cycle time comprised within the time period, at least:
determining a state of each accessory equipment to determine whether it is in the active state or in the inactive state, and to deduce therefrom an accessory power consumed over the cycle time by said accessory equipment when it is in the active state, on the basis of an electric consumption model associated with said accessory equipment which is contained in the control-command system; and
monitoring each actuation equipment comprising receiving, from the corresponding variable-speed drive, an actuation power consumed over the cycle time by said actuation equipment when it is in the active state.

14. The monitoring method according to claim 13, wherein the control-command system implements, subsequently to the time period, at least:
calculating, for each of the accessory equipment, a cumulated accessory power consumed over the time period by said accessory equipment, by summing up the accessory powers consumed over the cycle times where it has been in the active state;
calculating, for each of the actuation equipment, a cumulated actuation power consumed over the time period by said actuation equipment, by summing up the actuation powers consumed over the cycle times where it has been in the active state;
deducing a total accessory power corresponding to the sum of the cumulated accessory powers consumed over the time period by all of the accessory equipment;
deducing a total actuation power corresponding to the sum of the cumulated actuation powers consumed over the time period by all of the actuation equipment; and
comparing the supply power, the total accessory power and the total actuation power.

15. The monitoring method according to claim 14, wherein, subsequently to the time period, the control-command system constitutes a set of power data comprising at least:
the cumulated accessory powers of all of the accessory equipment over the time period;
the cumulated actuation powers of all of the actuation equipment over the time period;
the total accessory power;
the total actuation power; and
the supply power,
wherein the set of power data is time-stamped over the time period and then recorded in the memory of the control-command system.

16. The monitoring method according to claim 15, wherein the set of power data can be exported from the control-command system towards a digital twin of the crane modeled in a remote computer infrastructure, the set of power data being set in a data format compatible with the digital twin in order to be exploited by the latter.

17. The monitoring method according to claim 14, wherein the control-command system calculates, subsequently to the time period, an energy efficiency which is equal to the total actuation power divided by the supply power.

18. The monitoring method according to claim 17, wherein, subsequently to the time period, the control-command system constitutes a set of power data comprising at least:
the cumulated accessory powers of all of the accessory equipment over the time period;
the cumulated actuation powers of all of the actuation equipment over the time period;
the total accessory power;
the total actuation power; and
the supply power,
wherein the set of power data is time-stamped over the time period and then recorded in the memory of the control-command system, and,
wherein the set of power data also comprises the energy efficiency.

19. The monitoring method according to claim 13, wherein the control-command system determines, at each cycle time comprised within the time period, and according to a least one electrical equipment amongst the actuation equipment and the accessory equipment in the active state, at least one state of the crane amongst at least one off-service state in which all of the actuation elements are in the inactive state, and at least one on-service state in which at least one of the actuation elements is in the active state.

20. The monitoring method according to claim 19, wherein, when the at least one state of the crane corresponds to the on-service state for a given cycle time, the control-command system associates for each of the actuation equipment a movement selected at least amongst:
a dispense movement associated with a dispensing equipment amongst the actuation equipment during which a maneuver of dispensing a load along a jib of the crane is performed;
a hoist movement associated with a hoisting equipment amongst the actuation equipment during which a maneuver of hoisting a load is performed;
a steer movement associated with a steering equipment amongst the actuation equipment during which a maneuver of steering a jib is performed;
a translational movement associated with a translation equipment amongst the actuation equipment during which a maneuver of translating the crane is performed;
a lift movement associated with a lifting equipment amongst the actuation equipment during which a maneuver of lifting a lifting jib is performed; or
a mount movement during which mounting of the crane is performed, which mount movement is associated with a mounting equipment amongst the actuation equipment and selected at least amongst: a folding/unfolding equipment for folding/unfolding a mast and a jib, an anchoring equipment for anchoring the crane to the ground, a steering equipment for steering a base of the crane, a post equipment for actuating a mounting post.

21. The monitoring method according to claim 19, wherein, when the at least one state of the crane corresponds to the off-service state for a given cycle time, the control-command system associates for each of the accessory equipment the consumer function selected at least from amongst:
a heating function associated with a heating equipment amongst the accessory equipment for heating an operator cabin of the crane; and
an air-conditioning function associated with an air-conditioning equipment amongst the accessory equipment for conditioning an operator cabin of the crane.

22. The monitoring method according to claim 13, wherein the electric consumption model of each of the accessory equipment contains, in order to calculate the accessory power, at least:
the cycle time;
a power supply voltage for powering said accessory equipment when in the active state; and
a consumption current of the accessory equipment.

23. The monitoring method according to claim 13, wherein the cycle time is equal to 50 milliseconds, within a 20% margin.

24. The monitoring method according to claim 13, wherein the supply power is measured by a general electrical meter connected to the control-command system.
